(19) United States
(12) Patent Application Publication
(10) Pub. No.: US 2005/0089088 A1
(43) Pub. Date: Apr. 28, 2005

(54) Data transmission method and a data transmission apparatus between ground-isolated apparatuses

(75) Inventors: Masayuki Fukasawa, Tokyo (JP); Takeshi Shimomura, Tokyo (JP)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 10/946,769

(22) Filed: Sep. 22, 2004

(30) Foreign Application Priority Data
Oct. 24, 2003 (JP) 2003-365211

(51) Int. Cl. H04B 1/38

(52) U.S. Cl. 375/219

(57) ABSTRACT

An apparatus that transmits digital data between ground-isolated apparatuses at a high speed. Also, a method for transmitting digital data and a clock from a first apparatus to a second apparatus ground-isolated from the first apparatus comprising a step whereby reference signals are generated from the power source voltage of the first apparatus and a ground of the first apparatus; a step whereby a multiphase clock having the same base frequency as the maximum base frequency of this digital data is generated from this clock; a step whereby these digital data and these reference signals are compared and these comparison results are output; and a step whereby these comparison results are latched using this multiphase clock.

### FIELD OF THE INVENTION

The present invention pertains to a method and an apparatus for transmitting digital data signals and clock signals between ground-isolated apparatuses.

### DISCUSSION OF THE BACKGROUND ART

The test head of a semiconductor tester comprises multiple pins for contacting the integrated circuit, or the device under test, and an analog module and a digital module for testing the device under test connected to these pins. The analog module is a module that applies analog signals to the integrated circuit or measures the signals output from the integrated circuit. The analog module comprises an analog-digital converter or a digital-analog converter. The analog module comprises an analog circuit and a digital circuit. The analog module is such that the noise produced by the digital circuit will not be propagated to the analog circuit and therefore, the data and clock are transmitted with the ground being isolated at the digital circuit and the analog circuit. A photocoupler, pulse transformer, or differential signals have previously been used for transmission between such grounded apparatuses (for instance, Masatomi Suzuki, author, “Standard Edition: Designs of Transistor Circuits (Continued,” First Edition, CQ Publishers, December 1992, pp. 206-208. or Michio Okada, author, “Standard Edition: Designs of OP Amplifier Circuits,” Edition 19, CQ Publishers, May 2003, pp. 212-213).

When a photocoupler is used in 16-bit data communication, at least 17 photocouplers are needed for the data signals and clock signals. The current photocouplers have a transmission speed of only 10 MHz at most. Moreover, they are individual components that cannot be made into an integrated circuit and therefore, it is difficult to reduce the area required for mounting.

When a pulse transformer is used in 16-bit data communication, at least 17 pulse transformers are needed for the data signals and clock signals. Moreover, pulse transformers do not pass a direct current and therefore, the data to be transmitted must be modulated to alternating current. Furthermore, pulse transformers are individual components that cannot be integrated and therefore, it is difficult to reduce the area required for mounting.

When differential signals are used in 16-bit data communication, at least 34 differential amplifiers and 34 signal lines are needed for data signals and clock signals. The differential amplifier for transmission or reception of differential signals can be miniaturized by integration. However, this type of integrated circuit is expensive and electricity consumption is high. Moreover, integrated circuits capable of handling differential signals are large when compared to integrated circuits that only handle single end signals. Moreover, many signals lines are needed and therefore, the mounting space is also large.

In recent years progress has been made in terms of increasing the number of pins and increasing the speed of integrated circuits, or the device under test, and there is a demand for parallel testing of this type of integrated circuit. Therefore, a test head on which more analog modules can be mounted in a limited space is preferred. As previously mentioned, it is difficult to miniaturize analog modules that use photocouplers and pulse transformers. Moreover, it is necessary to transmit 100 MHz clock signals and therefore, photocouplers generally cannot be used. Furthermore, the cost of producing the IC accounts for much of the test cost in the semiconductor industry and therefore, there is no room for an increase in the cost of the semiconductor tester. Consequently, there is no room for an increase in the cost of the analog module unit and data transmission by differential signals is rarely used.

The present invention provides a unique apparatus for transmitting digital data between apparatuses that are ground-isolated that has a simple structure and lends itself to integration; is capable of high-speed data transmission; and is inexpensive.

### SUMMARY OF THE INVENTION

A method for transmitting digital data and a clock from a ground-isolated first apparatus to a second apparatus comprising a step whereby reference signals are generated from the power source voltage of this first apparatus and the ground of this first apparatus; a step whereby a multiphase clock having the same base frequency as the maximum base frequency of this digital data is generated from this clock; a step whereby these digital data and these reference signals are compared and these comparison results are output; and a step whereby these comparison results are latched using this multiphase clock.

The present invention also includes an apparatus that transmits digital data and a clock from a first apparatus to a second apparatus ground-isolated from the first apparatus, the apparatus comprising a means for generating reference signals from the power source voltage of the first apparatus and a ground of this first apparatus; a means for generating a multiphase clock having the same base frequency as the maximum base frequency of these digital data from this clock; a means for comparing these digital data and these reference signals; and a means for latching the comparison results of this comparison means using this multiphase clock. Preferably, the first apparatus comprises this reference signal generation means and the second apparatus comprises this comparison means. Moreover, the reference signal generation means divides the power source voltage and ground of this first apparatus by means of a resistor and generates reference signals.

Alternatively, the reference signal generation means divides the high level and the low level of these digital data by means of a resistor and generates reference signals.

The present invention also includes a transmitter that comprises a means for generating digital data in synchronization with a clock and a means for generating threshold voltage corresponding to the digital data and this clock; and in that it transmits the clock, the digital data, and the threshold voltage. This transmitter also comprises a means for dividing this clock into a multiphase clock, and in that it transmits a multiphase clock having the same base frequency as the maximum base frequency of these digital data in place of this clock.

The present invention also provides for a receiver that receives a clock, digital data, and threshold voltage; it comprises a first comparison means that compares this clock and this threshold voltage, a second comparison means that compares these digital data and this threshold voltage, and means for sampling output signals of this second comparison means in response to the output signals of this first comparison means; and it outputs the signals that have been sampled by this sampling means. Optionally, the clock is a multiphase clock having the same base frequency as the maximum base frequency of these digital data and these sampled signals are output selectively in response to this multiphase clock.

A digital data transmission apparatus which comprises: a transmitter which comprises: a data generator for generating digital data in synchronization with a first clock; and a voltage generator for generating first threshold voltage corresponding to the first digital data and the first clock; wherein the transmitter thereafter transmits the first clock, the first digital data, and the first threshold voltage; and a receiver which receives a second clock, a second digital data and a second threshold voltage, wherein the receiver comprises: a first comparator that compares the second clock and the second threshold voltage; a second comparator that compares the second digital data and the second threshold voltage; and a sampler that samples the second output signals from the second comparator in response to the first output signals from the first comparator, wherein the sampler thereafter outputs sampled signals from the sampler.

### BRIEF DESCRIPTION OF THE DRAWINGS

FIG. 1 is a drawing showing a digital data transmission apparatus that is the first embodiment of the present invention.

FIG. 2 is a drawing showing a digital data transmission apparatus that is the second embodiment of the present invention.

### DETAILED DESCRIPTION OF THE PREFERRED EMBODIMENT

The apparatus for transmitting digital data between ground-isolated apparatuses according to the present invention lends itself to integration, takes up a small facility space, provides for high-speed data transmission, and is inexpensive.

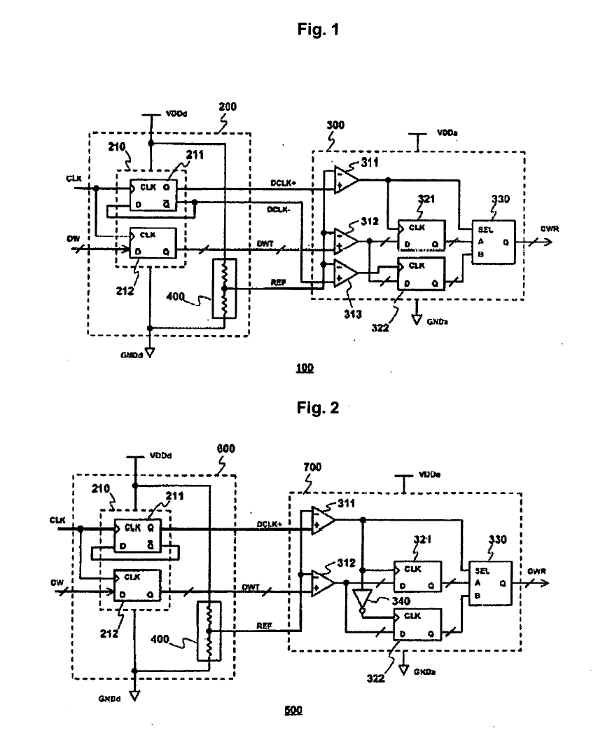

The present invention will now be described in detail based on the embodiments shown in the attached drawings. The first embodiment of the present invention is a digital data transmission apparatus and the block diagram of this apparatus is shown in FIG. 1. The digital data transmission apparatus 100 in FIG. 1 comprises a ground-isolated transmitter 200 and a receiver 300. Transmitter 200 is connected to a digital power source VDDd and a digital ground GNDd. The receiver 300 is connected to an analog power source VDDa and an analog ground GNDa. Moreover, digital ground GNDd and analog ground GNDa are isolated.

Transmitter 200 inputs a clock CLK and digital data DW having a width of at least one bit. Digital data DW are the digital data that will be transmitted. Transmitter 200 comprises a flip-flop array 210 connected to digital power source VDDd and digital ground GNDd and reference signal generator 400. Flip-flop array 210 inputs the clock CLK and the digital data DW. A flip-flop 211 inside flip-flop array 210 divides clock CLK in two and outputs these clocks. Noninverted divided clock DCLK+ and inverted divided clock DCLK− are output from flip-flop 211. Flip-flop 211 inside flip-flop array 210 latches and outputs digital data DW in response to clock CLK. The digital data output from flip-flop 211 are DWT here. One flip-flop 211 is shown in FIG. 1, but there are actually multiple flip flops 211 corresponding to at least the width (number of bits) of digital data DW. A reference signal generator 400 is the apparatus that generates noninverted divided clock DCLK+, inverted divided clock DCLK−, and threshold signals of digital data DWT, and outputs these as reference signals REF. Reference signal generator 400 is connected to digital power source VDDd and digital ground GNDd. The voltage of digital power source VDDd is divided by means of a resistor inside reference signal generator 400 to generate reference signals REF. The voltage level of reference signals REF depends on the properties of flip-flop array 210. By means of the present embodiment, the voltage level of reference signals REF is the potential between the high level and the low level of the output signals of flip-flop array 210. Transmitter 200 transmits noninverted divided clock DCLK+, inverted divided clock DCLK−, digital data DWT, and reference signals REF.

Receiver 300 receives noninverted divided clock DCLK+, inverted divided clock DCLK−, digital data DWT, and reference signals REF transmitted from transmitter 200. Receiver 300 comprises a comparator 311, another comparator 312, and yet another comparator 313; a D flip-flop 321 and another D flip-flop 322; and a signal selector 330. Comparators 311, 312, and 313 are input reference signals REF to the respective inversion input terminal. Moreover, noninverted divided clock DCLK+ is input to the noninversion input terminal of comparator 311. Inverted divided clock DCLK− is input to the noninversion input terminal of comparator 313. Digital data DWT are input to the noninversion input terminal of comparator 312. The output terminal of comparator 311 is connected to the clock input terminal of flip-flop 321 and a selection terminal SEL of signal selector 330. The output terminal of comparator 313 is connected to the clock input terminal of flip-flop 322. The output terminal of comparator 312 is connected to the data input terminal of flip-flop 321 and flip-flop 322. Flip-flop 321 and flip-flop 322 latch and output the input digital data in response to the clock that is input. One each of comparator 312, flip-flop 321, and flip-flop 322 are shown in FIG. 1, but there are actually multiple comparators 312, flip-flops 321, and flip-flops 322 corresponding to at least the width (number of bits) of digital data DW. Signal selector 330 is the apparatus that selects and outputs either the digital data input to input terminal A or the digital data input to input terminal B in response to the signals input to selection terminal SEL. That is, signal selector 330 performs a type of series-parallel conversion. It should be noted that input terminal A of signal selector 330 is connected with the output terminal of flip-flop 321. Input terminal B of signal selector 330 is connected with the output terminal of flip-flop 322. Receiver 300 outputs digital data DWR.

According to the present invention, relatively large individual elements such as photocouplers are not necessary with the apparatus for transmitting digital data between mutually ground-isolated apparatuses and therefore, facility space is small and the apparatus lends itself to integration. Moreover, the maximum base frequency of the digital data and the base frequency of the clock are the same with the digital data transmission apparatus of the present invention and therefore, high-speed data transmission is possible. The maximum base frequency of digital data is the base frequency of digital data alternating between 1 and 0. Furthermore, expensive individual components such as photocouplers and operational amplifiers are not necessary and therefore, the digital data transmission apparatus of the present invention is inexpensive.

The number of clock lines transmitted from transmitter 200 to receiver 300 of digital data transmission apparatus 100 can also be reduced by ½. This type of digital data transmission apparatus is shown in FIG. 2 as a second embodiment of the present invention. A digital data transmission apparatus 500 in FIG. 2 comprises a transmitter 600 and a receiver 700. Transmitter 600 has virtually the same structure as transmitter 200. Transmitter 600 differs from transmitter 200 in that inverted divided clock DLK− is not transmitted. Moreover, a receiver 700 has virtually the same structure as receiver 300. Receiver 700 differs from receiver 300 in that there is no comparator 313, and the clock input terminal of flip-flop 322 is connected to the output terminal of a comparator 311 through an inverter 340. As shown in FIG. 2, the number of clock lines transmitted from the transmitter to the receiver of digital data transmission apparatus 500 is half the number transmitted with digital data transmission apparatus 100. On the other hand, digital data transmission apparatus 500 is limited by the propagation delay time of inverter 340 and there are cases where the transmission speed is slower than that of digital data transmitter 100.

Receivers 300 and 700 in FIGS. 1 and 2 can also comprise reference signal generator 400. However, in this case, the noise that is received from the outside during transmission cannot be completely removed from noninverted divided clock DCLK+, inverted divided clock DCLK−, and digital data DWT. For instance, in FIG. 1, receiver 300 comprises reference signal generator 400. In this case, digital power source VDDd and digital ground GNDd are introduced from transmitter 200 to receiver 300 in place of reference signals REF. Moreover, the voltage of digital power source VDDd is divided to generate reference signals REF inside receiver 300. The noise received from the outside is simultaneously divided at this time. As a result, the noise that is received from the outside during transmission cannot be completely removed from digital data DWT, and the like.

Moreover, there is one reference signal REF in FIGS. 1 and 2, but there are cases where multiple reference signals are generated and transmitted. For instance, when the theoretical output level of flip-flop 211 and flip-flop 212 is different, it is necessary to generate reference signals corresponding to the respective flip-flop (211, 212) output in order to obtain a completely insulated effect on the side of receiver 300 and receiver 700. In such a case, reference signal generator 400 in FIGS. 1 and 2 is such that multiple reference signals are generated, or a reference signal generator different from reference signal generator 400 is added.

The clock that is transmitted in FIGS. 1 and 2 is not limited to a two-phase clock. One requirement of the present invention is that the maximum base frequency of the digital data is the same as the base frequency of the clock and therefore, digital data transmission apparatuses 100 and 500 in FIGS. 1 and 2 can also be such that a 3-phase clock obtained by dividing the original clock into three clocks or a four-phase clock obtained by dividing the original clock into four clocks is transmitted.

1. A digital data transmission method for transmitting digital data and a clock from a first apparatus to a second apparatus ground-isolated from said first apparatus, said method comprising:
generating reference signals from a power source voltage of said first apparatus and a ground of said first apparatus;
generating a multiphase clock having the same base frequency as the maximum base frequency of said digital data of said clock;
comparing said digital data and said reference signals and outputting the comparison results; and
latching said comparison results using said multiphase clock.

2. A digital data transmission apparatus that transmits digital data and a clock from a first apparatus to a second apparatus ground-isolated first apparatus from said first apparatus, said transmission apparatus comprising:
a signal generator that generates said reference signals from a power source voltage of said first apparatus and a ground of said first apparatus;
a multiphase clock generator having the same base frequency as the maximum base frequency of said digital data from said clock;
a comparator for comparing said digital data and said reference signals; and
a latching device for latching the comparison results of said comparator using said multiphase clock.

3. The digital data transmission apparatus according to claim 2, wherein said first apparatus comprises said signal generator and said second apparatus comprises said comparator.

4. The digital data transmission apparatus according to claim 2, wherein said signal generator divides between said power source voltage and said ground of said first apparatus by a resistor to generate said reference signals.

5. The digital data transmission apparatus according to claim 2, wherein signal generator divides between the high level and the low level of said digital data by a resistor to generate said reference signals.

6. A transmitter which comprises:
a data generator for generating digital data in synchronization with a clock; and
a voltage generator for generating threshold voltage corresponding to said digital data and said clock; wherein said transmitter thereafter transmits said clock, said digital data, and said threshold voltage.

7. The transmitter according to claim 6, further comprising a device for dividing this clock into a multiphase clock, wherein said transmitter transmits said multiphase clock having the same base frequency as the maximum base frequency of said digital data in place of said clock.

8. A receiver which receives a clock, digital data and threshold voltage, wherein said receiver comprises:
a first comparator that compares said clock and said threshold voltage;
a second comparator that compares said digital data and said threshold voltage; and
a sampler that samples the second output signals from said second comparator in response to the first output signals from said first comparator, wherein said sampler thereafter outputs sampled signals from said sampler.

9. The receiver according to claim 8, wherein said clock is a multiphase clock having the same base frequency as the maximum base frequency of said digital data and said sampled signals are output selectively in response to said multiphase clock.

10. A digital data transmission apparatus which comprises:
a transmitter which comprises: a data generator for generating digital data in synchronization with a first clock; and a voltage generator for generating first threshold voltage corresponding to said first digital data and said first clock; wherein said transmitter thereafter transmits said first clock, said first digital data, and said first threshold voltage; and
a receiver which receives a second clock, a second digital data and a second threshold voltage, wherein said receiver comprises: a first comparator that compares said second clock and said second threshold voltage;a second comparator that compares said second digital data and said second threshold voltage; and a sampler that samples the second output signals from said second comparator in response to the first output signals from said first comparator, wherein said sampler thereafter outputs sampled signals from said sampler.
